(19) United States
(12) Patent Application Publication
(10) Pub. No.: US 2016/0213028 A1
(43) Pub. Date: Jul. 28, 2016

(54) KITS AND METHODS FOR NUTRITIONALLY BALANCED HOME COOKED PET FOOD

(71) Applicant: NESTEC SA, VEVEY (CH)

(72) Inventors: Andrea Faccio, St. Louis, MO (US); Ivan Filipi, St. Louis, MO (US); Asa M. Gore, St. Louis, MO (US); Amanda Hassner, St. Louis, MO (US); Nicolas Mutis, St. Louis, MO (US)

(21) Appl. No.: 15/001,731

(22) Filed: Jan. 20, 2016

Related U.S. Application Data
(60) Provisional application No. 62/107,764, filed on Jan. 26, 2015.

(51) Int. Cl. A23K 1/18

(52) U.S. Cl. CPC A23K 1/1853; A23K 1/1603; A23K 1/175

(57) ABSTRACT

In one aspect, a kit comprises a cooking aid comprising vitamins and minerals; and a component that identifies ingredients, amounts thereof, and instructions for preparing a pet food for a companion animal from the ingredients and the cooking aid. In another aspect, a method comprises providing a cooking aid comprising vitamins and minerals, together with material on which information is printed that identifies ingredients, amounts thereof, and instructions for preparing a pet food for a companion animal from the cooking aid and the ingredients. Preferably the pet food meets the minimum nutrient requirements for complete and balanced nutrition for the companion animal as established by the Association of American Feed Control Officials (AAFCO).

### CROSS REFERENCE TO RELATED APPLICATIONS

This application claims priority to U.S. Provisional Application No. 62/107,764 filed Jan. 26, 2015, the disclosure of which is incorporated herein by this reference.

### BACKGROUND

The present disclosure generally relates to kits and methods for preparing a food product for companion animals. More specifically, the present disclosure relates to a cooking aid, such as a dry mix, provided with a recipe such that the use of the cooking aid in the recipe delivers a complete and balanced home-cooked meal for companion animals.

Pets with allergies, skin conditions, or periodic gastrointestinal disturbances typically respond well to a home-cooked diet. Mitigating or preventing such ailments can improve the mood and behavior of the pet for increased enjoyment of their company by the owner. However, pet owners who prepare home-made meals usually fail to assure complete and balanced nutrition for the pet, as in complete commercial (dry or wet) pet food.

### SUMMARY

The present disclosure provides a solution for nutritional deficits in home-cooked meals for companion animals. In an aspect of the present disclosure, a kit comprises (i) a recipe for the pet owner to purchase fresh ingredients, (ii) a cooking aid (e.g. a nutrient powder blend) essential for the pet's health pursuant to the regulatory standards of the Association of American Feed Control Officials (AAFCO), and (iii) instructions to make a home-cooked meal for the companion animal. When the cooking aid is used in the home-cooked meal recipe, the resulting meal yields complete and balanced nutrition for a companion animal, such as an adult dog.

Accordingly, in a general embodiment, the present disclosure provides a kit comprising: a cooking aid comprising vitamins and minerals; and a component that identifies ingredients, amounts thereof, and instructions for preparing a pet food for a companion animal from the ingredients and the cooking aid.

In an embodiment, he cooking aid is formulated such that use of the cooking aid with the amounts of the ingredients, according to the instructions, forms the pet food to meet the minimum nutrient requirements for complete and balanced nutrition for the companion animal as established by the Association of American Feed Control Officials (AAFCO). The cooking aid can be formulated to meet the minimum nutrient requirements for complete and balanced nutrition for a dog. The cooking aid can be formulated to meet the minimum nutrient requirements for complete and balanced nutrition for a cat.

In an embodiment, the cooking aid is a powder. The kit can comprise a sachet that contains at least a portion of the powder; and at least one of the ingredients, the amounts thereof, or the instructions can be at least partially printed on the sachet.

In an embodiment, the kit comprises a single package that comprises the cooking aid and the component that identifies the ingredients, the amounts thereof, and the instructions.

In an embodiment, the cooking aid comprises macronutrients.

In another embodiment, the present disclosure provides a method comprising providing a cooking aid comprising vitamins and minerals, together with material on which information is printed that identifies ingredients, amounts thereof, and instructions for preparing a pet food for a companion animal from the cooking aid and the ingredients.

In an embodiment, the pet food meets the minimum nutrient requirements for complete and balanced nutrition for the companion animal as established by the Association of American Feed Control Officials (AAFCO).

In an embodiment, the cooking aid is physically associated with the material on which the information is printed.

In an embodiment, the cooking and the material comprising the information are provided as a kit, and the method comprises providing a plurality of kits in which a first subset of the plurality of kits is designed for a cat and a second subset of the plurality of kits is designed for a dog. A first portion of the first subset of kits can be designed for a cat with an age below a predetermined value, and a second portion of the first subset of kits can be designed for a cat with an age above the predetermined value. A first portion of the second subset of kits can be designed for a dog with an age below a predetermined value, and a second portion of the second subset of kits can be designed for a dog with an age above the predetermined value.

In another embodiment, the present disclosure provides a method comprising the steps of using a cooking aid comprising vitamins and minerals with other ingredients in accordance with cooking instructions physically associated with a container housing the cooking aid, to prepare a pet food for a companion animal from the cooking aid and the other ingredients.

In an embodiment, the method comprises administering the pet food to a cat.

In an embodiment, the method comprises administering the pet food to a dog.

In an embodiment, the method comprises mixing the cooking aid with at least one of the other ingredients before performing a heating step.

In an embodiment, the method comprises mixing the cooking aid with a first ingredient of the other ingredients before mixing the first ingredient with a second ingredient of the other ingredients.

In an embodiment, the pet food meets the minimum nutrient requirements for complete and balanced nutrition for the companion animal as established by the Association of American Feed Control Officials (AAFCO).

An advantage of the present disclosure is to provide a tasty meal for pets, such as dogs and cats, without the worry of ingredient safety.

Another advantage of the present disclosure is to provide complete and balanced nutrition for pets, such as cats and dogs e.g. adult dogs.

Still another advantage of the present disclosure is to provide a meal to a pet that is home-cooked but nevertheless designed by experts in pet nutrition.

An additional advantage of the present disclosure is to provide pet nutrition with enhanced palatability.

Another advantage of the present disclosure is to provide complete pet nutrition at an affordable price point by employing a cooking aid in a home-cooked meal.

Yet another advantage of the present disclosure is to provide a final product that has the appearance and the aroma of a traditional home-cooked meal and is nutritionally complete and balanced for a companion animal.

Another advantage of the present disclosure is to provide complete and balanced nutrition in a form that has greater appeal for companion animals relative to commercial complete and balanced pet foods.

An additional advantage of the present disclosure is to provide a pet owner with the satisfaction of providing a nutritionally complete home-cooked meal to their pet.

Additional features and advantages are described in, and will be apparent from, the following Detailed Description and the Figures.

### BRIEF DESCRIPTION OF THE DRAWINGS

FIG. 1 is a photograph of a food product prepared from a kit provided by the present disclosure.

### DETAILED DESCRIPTION

All percentages expressed herein are by weight of the total weight of the composition unless expressed otherwise. When reference is made to the pH, values correspond to pH measured at 25° C. with standard equipment. As used herein, “about” is understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, all numerical ranges herein should be understood to include all integers, whole or fractions, within the range.

The terms “food,” “food product” and “food composition” mean a product or composition that is intended for ingestion by an animal, including a human, and provides at least one nutrient to the animal. “Macronutrients” means proteins, fats, and carbohydrates. The term “pet food” means any food composition intended to be consumed by a pet. The term “companion animal” means a dog or a cat.

As used herein, including the appended claims, a “kit” means that the identified components are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be one or more containers that contain the identified components, and the one or more containers are physically associated such that they are considered a unit for manufacture, distribution, sale or use. A “sachet” is a small disposable bag or pouch, for example made of cellophane, plastic, foil, or combination of thereof.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “an ingredient” or “a method” includes a plurality of such “ingredients” or “methods.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein.

The present disclosure provides a home-made meal made from two components, namely (i) a cooking aid comprising vitamins, minerals and macronutrients, and (ii) ingredients and amounts thereof identified by a recipe provided with the cooking aid. The cooking aid is preferably a powder but can instead be formulated and provided as a liquid, a gel or another form. The recipe can comprise instructions, such as mixing and cooking instructions, for making the home-made meal from the cooking aid and the other ingredients identified in the recipe. The resultant home-made meal yields complete and balanced nutrition according to AAFCO for a companion animal, such as adult dogs of all sizes.

In an embodiment, the cooking aid itself provides the vitamins and minerals necessary for complete and balanced nutrition according to AAFCO for a companion animal. In another embodiment, the cooking aid and the ingredients identified in the recipe in the amounts identified by the recipe, in combination together, provide the vitamins and minerals necessary for complete and balanced nutrition according to AAFCO for a companion animal.

For example, a nutrient powder blend can be prepared by dry blending a specific formula and packing the dry blend at a formulated dose into a sachet. The sachet can be hermetically sealed and included in a meal kit. The meal kit can include a recipe for a home-made meal, the recipe identifying ingredients to purchase and cooking instructions.

Preferably the cooking aid is used in the preparation of the pet food and not merely added to the pet food after preparation. For example, the recipe can include one or more heating steps, and the cooking aid can be added to the other ingredients before at least one of the heating steps. As another example, the cooking aid can be mixed with the other ingredients such that at least one of the other ingredients is added to the mixture after the cooking aid. In an embodiment, the pet food resulting from use of the cooking aid in the recipe has the nutrients from the cooking aid substantially homogeneously dispersed therein.

In an embodiment, the recipe can be at least partially printed on the sachet. Alternatively or additionally, the recipe can be at least partially printed on a container forming at least part of the meal kit (e.g. a container in which the sachet is positioned when purchased) and/or a material (e.g. a sheet of paper) physically associated with or positioned within such a container. In an embodiment, the recipe is provided on a website, and the meal kit includes the website address printed on the sachet, a container forming at least part of the meal kit, and/or a material provided within a container forming at least part of the meal kit. Preferably, the recipe and the cooking aid are provided together in a single package.

The cooking aid (e.g. a nutrient powder blend) and the accompanying recipe are preferably formulated to produce a complete and balanced pet food according to AAFCO standards for the corresponding companion animal (dog or cat). In an embodiment, the cooking aid and the accompanying recipe can be formulated more specifically based on a variety of factors such as the breed of the dog or cat; the companion animal's age, body weight, general health, sex, and diet; the companion animal's consumption rate; the purpose for which the food product is administered to the companion animal; and the like.

The cooking aid comprises vitamins and minerals and optionally macronutrients as well. Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like.

Preferably the ingredients to which the cooking aid is added are raw macroingredients that can be purchased from a local market, shop or supermarket. Preferably these ingredients comprise at least one ingredient that is substantially unprocessed.

These ingredients can comprise vegetables selected not only for their nutritional value but also chosen based on their color and the aesthetic appearance they provide to the final product. Non-limiting examples of suitable vegetables include potatoes, squash, zucchini, spinach, radishes, asparagus, tomatoes, cabbage, peas, carrots, spinach, corn, green beans, lima beans, broccoli, brussel sprouts, cauliflower, celery, cucumbers, turnips, yams and combinations thereof.

The ingredients to which the cooking aid is added can comprise a meat material, for example as a protein source. Non-limiting examples of suitable meat materials include meat (i.e. skeletal tissue and non-skeletal muscle) from mammals, fish and fowl (e.g. poultry, beef, pork, lamb and fish, especially those types of meats suitable for pets) and also include meat by-products (i.e. the non-rendered clean parts, other than meat, derived from slaughtered mammals, fowl or fish). More specific non-limiting examples include whole-carcass beef and mutton, lean pork trim, beef shanks, veal, beef and pork cheek meat; meat by-products such as lips, tripe, hearts, and tongues; and meat by-products approved for use in animal foods, such as mechanically deboned beef, chicken, or fish, beef and pork liver, lungs, kidney, and the like.

The ingredients to which the cooking aid is added can comprise any suitable grain that adds a pleasant taste and consistency to the final product. Non-limiting examples of suitable grains include powdered barley, barley, rice, wild rice, brown rice, oats and millet.

The ingredients to which the cooking aid is added can comprise spices and herbs to improve the taste and aroma of the final product. Non-limiting examples of suitable spices include parsley, sage, rosemary, basil, thyme and chives.

The ingredients to which the cooking aid is added can comprise pasta. Non-limiting examples of suitable pasta include rotini, macaroni, bow tie pasta, Macaroni, Fusilli, Tortellini, Penne and other pasta types.

The ingredients to which the cooking aid is added can comprise an oil. Non-limiting examples of suitable oils are soybean oil, corn oil, sunflower oil, high oleic sunflower oil, olive oil, canola oil, safflower oil, peanut oil, palm oil, cottonseed oil, coconut oil, almond oil, hazelnut oil, grapeseed oil, and combinations thereof.

As noted above, the cooking aid (e.g. a nutrient powder blend) and the accompanying recipe are preferably formulated to produce a complete and balanced pet food according to AAFCO standards for the corresponding companion animal (dog or cat). For example, the cooking aid and the accompanying recipe can be formulated to produce a complete and balanced dog food according to AAFCO standards for complete and balanced nutrition for an adult dog. In such embodiments, the cooking aid and the accompanying recipe can be formulated to provide the following, on a dry matter basis: at least 22.0% protein, at least 0.62% arginine, at least 0.22% histidine, at least 0.45% isoleucine, at least 0.72% leucine, at least 0.77% lysine, at least 0.53% methionine-cysteine, at least 0.89% phenylalanine-tyrosine, at least 0.58% threonine, at least 0.20% tryptophan, at least 0.48% valine, at least 8.0% crude fat, at least 1.0% linoleic acid, 1.0% to 2.5% calcium, 0.8% to 1.6% phosphorus, a Ca:P ratio of 1:1 to 2:1, at least 0.6% potassium, at least 0.3% sodium, at least 0.45% chloride, and magnesium from 0.04% to 0.3%.

In such embodiments, the cooking aid and the accompanying recipe can be formulated to provide the following: 80 to 3,000 mg/kg of iron, 7.3 to 250 mg/kg of copper, at least 5.0 mg/kg of manganese, 120 to 1,000 mg/kg of zinc, 1.5 to 50 mg/kg of iodine, 0.11 to 2 mg/kg of selenium, 5,000 to 250,000 IU/kg of Vitamin A, 500 to 5,000 IU/kg of Vitamin D, 50 to 1,000 IU/kg of Vitamin E, at least 1.0 mg/kg of thiamine, at least 2.2 mg/kg of riboflavin, at least 10 mg/kg of pantothenic acid, at least 11.4 mg/kg of niacin, at least 1.0 mg/kg of pyridoxine, at least 0.18 mg/kg of folic acid, at least 0.022 mg/kg of Vitamin B12, and at least 1,200 mg/kg of choline.

As another example, the cooking aid and the accompanying recipe can be preferably formulated to produce a complete and balanced dog food according to AAFCO standards for adult maintenance. In such embodiments, the cooking aid and the accompanying recipe can be formulated to provide the following, on a dry matter basis: at least 18.0% protein, at least 0.51% arginine, at least 0.18% histidine, at least 0.37% isoleucine, at least 0.59% leucine, at least 0.63% lysine, at least 0.43% methionine-cysteine, at least 0.73% phenylalanine-tyrosine, at least 0.48% threonine, at least 0.16% tryptophan, at least 0.39% valine, at least 5.0% crude fat, at least 1.0% linoleic acid, 0.6% to 2.5% calcium, 0.5% to 1.6% phosphorus, a Ca:P ratio of 1:1 to 2:1, at least 0.6% potassium, at least 0.06% sodium, at least 0.09% chloride, and magnesium from 0.04% to 0.3%.

In such embodiments, the cooking aid and the accompanying recipe can be formulated to provide the following: 80 to 3,000 mg/kg of iron, 7.3 to 250 mg/kg of copper, at least 5.0 mg/kg of manganese, 120 to 1,000 mg/kg of zinc, 1.5 to 50 mg/kg of iodine, 0.11 to 2 mg/kg of selenium, 5,000 to 250,000 IU/kg of Vitamin A, 500 to 5,000 IU/kg of Vitamin D, 50 to 1,000 IU/kg of Vitamin E, at least 1.0 mg/kg of thiamine, at least 2.2 mg/kg of riboflavin, at least 10 mg/kg of pantothenic acid, at least 11.4 mg/kg of niacin, at least 1.0 mg/kg of pyridoxine, at least 0.18 mg/kg of folic acid, at least 0.022 mg/kg of Vitamin B12, and at least 1,200 mg/kg of choline.

The skilled artisan will readily understand that the two above examples can be re-formulated for different types of dogs and also reformulated for cats and specific types thereof. Accordingly, the present disclosure also provides a method comprising providing a plurality of meal kits, such that the cooking aid and the recipe in each meal kit is formulated for a specific type of companion animal and their nutritional needs, for example a meal kit for an adult dog, a meal kit for a puppy, a meal kit for an adult cat, a meal kit for a kitten, etc.

Of course, the embodiments disclosed herein can also be updated to reflect current AAFCO standards if such standards change.

### EXAMPLE

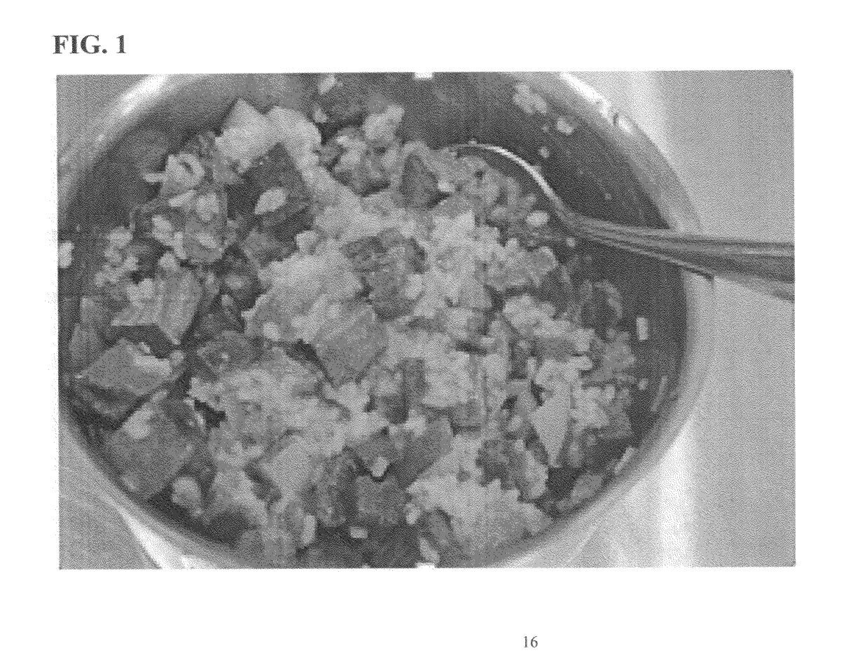

The following non-limiting example is included merely for illustration. The resultant pet food is shown in FIG. 1. Although this example generally illustrates a meal for a dog, the meal can be modified for a cat by changing the Nutrient Powder Blend to be formulated for a cat pursuant to AAFCO guidelines.

Caldo de Costilla (Rib Soup)

Ingredients

| | | |
|---|---|---|
| Beef | 450 | grams |
| Rice | 150 | grams (¾ cup) |
| Potato (criolla) | 30 | grams (2 tablespoons) |
| Carrots | 20 | grams (1½ tablespoons) |
| Water | 400 | grams (1¾ cups) |
| Nutrient Powder Blend | 50 | grams (3 tablespoons) |
| Tomato | 10 | grams (¾ tablespoons) |
| Corn Oil | 20 | grams (1½ tablespoons) |

### Nutrient Powder Blend Formulated According to AAFCO Standards for Complete and Balanced Nutrition for an Adult Dog

Calcium Carbonate
Vitamin E (500)
Vit A Vanco 500
Vitamin B12 (0.5%)
Vitamin D (500,000)
Pyridoxine HLC
Riboflavin
Niacin 99.5%
Calcium Pan (91.96%)
Thiamine Mononitrate-98.5%
Acid Folic (87.6%)
Manganese Sulfate
Copper Sulfate Pentahydrate
Ferrous Sulfate
Calcium Iodate-10.28%/65%
Sodium Selenite
Zinc Sulfate Pf
Maltodextrin 10 DE
Inactivated Brewer's Yeast
Tricalcium Phosphate Coarse
Salt
Potassium Chloride
Choline Chloride Dry

### Cooking Instructions

1) Gather the ingredients
2) Cook beef in water at a low simmer for 20 minutes
3) Add rice, potato, carrots and Nutrient Powder Blend, stirring powder into solution
4) Cover and simmer for another 20 minutes
5) Uncover and add tomatoes and oil
6) Allow to cool and serve
7) Refrigerate unused food and use within 4 days from cooking time

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A kit comprising:
a cooking aid comprising vitamins and minerals; and
a component that identifies ingredients, amounts thereof, and instructions for preparing a pet food for a companion animal from the ingredients and the cooking aid.

2. The kit of claim 1 wherein the cooking aid is formulated such that use of the cooking aid with the amounts of the ingredients, according to the instructions, forms the pet food to meet the minimum nutrient requirements for complete and balanced nutrition for the companion animal as established by the Association of American Feed Control Officials (AAFCO).

3. The kit of claim 2 wherein the cooking aid is formulated to meet the minimum nutrient requirements for complete and balanced nutrition for a dog.

4. The kit of claim 2 wherein the cooking aid is formulated to meet the minimum nutrient requirements for complete and balanced nutrition for a cat.

5. The kit of claim 1 wherein the cooking aid is a powder.

6. The kit of claim 5 comprising a sachet that contains at least a portion of the powder; and at least one of the ingredients, the amounts thereof, or the instructions are at least partially printed on the sachet.

7. The kit of claim 1 comprising a single package that comprises the cooking aid and the component that identifies the ingredients, the amounts thereof, and the instructions.

8. The kit of claim 1 wherein the cooking aid comprises macronutrients.

9. A method comprising providing a cooking aid comprising vitamins and minerals, together with material on which information is printed that identifies ingredients, amounts thereof, and instructions for preparing a pet food for a companion animal from the cooking aid and the ingredients.

10. The method of claim 9 wherein the pet food meets the minimum nutrient requirements for complete and balanced nutrition for the companion animal as established by the Association of American Feed Control Officials (AAFCO).

11. The method of claim 9 wherein the cooking aid is physically associated with the material on which the information is printed.

12. The method of claim 9 wherein the cooking and the material comprising the information are provided as a kit, and the method comprises providing a plurality of kits in which a first subset of the plurality of kits is designed for a cat and a second subset of the plurality of kits is designed for a dog.

13. The method of claim 12, wherein a first portion of the first subset of kits is designed for a cat with an age below a predetermined value, and a second portion of the first subset of kits is designed for a cat with an age above the predetermined value.

14. The method of claim 12, wherein a first portion of the second subset of kits is designed for a dog with an age below a predetermined value, and a second portion of the second subset of kits is designed for a dog with an age above the predetermined value.

15. A method comprising the steps of using a cooking aid comprising vitamins and minerals with other ingredients in accordance with cooking instructions physically associated with a container housing the cooking aid, to prepare a pet food for a companion animal from the cooking aid and the other ingredients.

16. The method of claim 15 comprising administering the pet food to a cat.

17. The method of claim 15 comprising administering the pet food to a dog.

18. The method of claim 15 comprising mixing the cooking aid with at least one of the other ingredients before performing a heating step.

19. The method of claim 15 comprising mixing the cooking aid with a first ingredient of the other ingredients before mixing the first ingredient with a second ingredient of the other ingredients.

20. The method of claim 15 wherein the pet food meets the minimum nutrient requirements for complete and balanced nutrition for the companion animal as established by the Association of American Feed Control Officials (AAFCO).
